(19) United States
(12) Patent Application Publication
(10) Pub. No.: US 2006/0080237 A1
(43) Pub. Date: Apr. 13, 2006

(54) Combined asset debt elimination membership organization and debt elimination method

(76) Inventor: Kevin Mallory, Valrico, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 10/963,020

(22) Filed: Oct. 12, 2004

(51) Int. Cl. G06Q 40/00

(52) U.S. Cl. 705/40

(57) ABSTRACT

A debt elimination method and organization by which individuals join an organization and its active members are eligible to be randomly selected to have their personal debt paid based on the principal sum of membership dues. Personal debt of members is paid on a monthly basis based on the total amount accrued per month and members are randomly selected until the total amount accrued is paid out. In the event a members debt exceeds the amount available, that individual will receive the remaining amount from the following months' sum before the next member is randomly selected. Each month, the sum of the amount available will change based on the increase or decrease of active membership. The individual debt will be paid directly to the creditor not the member. The amount paid toward the member's debt will be considered a gift from each active member.

### FIELD OF THE INVENTION

The invention relates generally to a method whereby individuals register and pay a registration fee and dues as members of an organization for the purpose of receiving a monthly newsletter and having their personal debt paid as well as contribute to the payment of debt of other active members.

### BACKGROUND OF THE INVENTION

There are some things we all have in common. It extends beyond education, racial, political, and social status. It is debt. The use of credit cards and the low savings rate in the United States alone have reached unparalleled levels. There are more individuals with substantial debt than any other time in history. The average cost of a home in the United States is $250,000 and the average consumer carries over $9,000 in credit card debt coupled with car loans that average between $15,000 and $20,000 with most families requiring two reliable autos because of the need of dual incomes. Based on that information alone an average American family can have combined minimum $298,000 in debt at a given time. This is without considering the high cost of living in particular areas of the U.S. The average home loan is 30 years, the average auto loan is 60 months and consumers average 5-8 years to pay off credit card debts. With the interest payments, Americans pay over $1 billion per year to creditors. Eighteen percent of Americans disposable income now goes to service consumer debt while we save less than two percent of our disposable income. Yet most consumers keep spending. Bankruptcies have risen consistently since 1980 during fairly sound economic times. Individuals are working later into their golden years due to increased medical costs, more debt and the need to support younger debt ridden family members. There has to be a better way. Similar debt issues are common in most industrialized nations around the world.

What if there was a way for individuals to totally pay off their primary debt (house, car and credit cards) by simply leveraging their purchasing power? After months of observing the multitude of mortgage related debt consolidation programs, credit-counseling services, credit card transfer and consolidation offers, none of these observed programs did anything to help the overall problem. As most people are aware, it is not how much you make but how much you owe. The object of the present invention was to develop a method by which individuals can pay off their personal debt and start to invest in themselves and build personal wealth with no major debt to be concerned with.

What if there was also a way to benefit from having debt paid with no processing fees and with favorable tax considerations? Many individuals use second mortgages to pay off debt, only to have a large portion of the loan eaten away in fees. Many transfer debt from credit card to credit card in order to pay little or no interest for a particular time. Many individuals do not keep their cars long enough to pay them off before they are purchasing another new car. Individuals are not aware of the tax liabilities of receiving large sums of money. After federal, state and local taxes are levied the individual is left with a portion of what they thought would solve their debt problems. Credit counseling services do no more than make you feel good about paying less for a longer period of time.

### SUMMARY OF THE INVENTION

An object of the present invention is the have an organizational structure that can leverage the purchasing power of individuals through a random selection process making them totally debt free. The organization is set up to spend the total sum of those funds available based on active membership on a monthly basis. Individual debt is paid from combined dues equal to the amount received as long as there were funds available.

The average American has what is called disposable income. Disposable income are funds we have remaining after we pay our living expenses and debt. We use these funds to purchase music CD's, movie tickets, books, computer games, take trips to theme parks, etc. What if using a fraction of our disposable income, combined with that of other members' disposal income, we are able to pay off primary debt of individuals on a random and consistent basis?

What if there was an organization that did not have a primary goal of profit? A non-profit organization with a goal to give away its funds by paying the debts of its members. This is unheard of in today's business world. The primary goal of every traditional business is to increase profits not give it away, until now. With this system it is possible with the exception of a small administrative cost to provide this valued service to individual members of the organization on a consistent basis.

It is anticipated that there is a high demand for this program, if not for the simple reason it has not been done before. It is based on a simple common sense approach, not business savvy. However, the business world is not accustomed to providing valued service to individuals where they see more money leave an organization than remain in the corporate account. Can it be implemented without the traditional corporate structure? Can all active parties win in this debt elimination initiative? Where else in the financial or business world is anyone combining a fraction of funds to pay off consumer debt completely and efficiently?

Generally, the invention is a combined asset debt elimination membership organization and debt elimination method where as discussed above an individual contributes in the form of dues and registration fees to an organization. A member name is randomly selected each month and the available funds of the organization pay the debts of the member whose name is selected for that month. A more detailed description of this debt elimination organizational program is described below.

### DETAILED DESCRIPTION OF THE INVENTION

An individual based on his or her personal debt and opportunity to benefit, elects to joins the organization. He or she via the organization Web site or organization office registers and becomes an active member of the organization. Of course, a new member can register by mail as well.

The individual can register in the organization for a specific period of time, for example 1, 3, 6 or 12 months, or 1 or 2 years or fractions thereof. Each individual is also required to pay a one time, life-time registration fee.

A month (30 consecutive days) for the purpose of the organization will end with the random selection taking place the day after or the next business day if the next day is a holiday or weekend. The random selection process will be conducted with one individual (officer or employee of the organization) initiating the random selection process and no less than two witnesses who may or may not be employees of the organization.

The individual registration will include but not be limited to their name, address, email, primary and secondary phone numbers. The organization will use this information to contact the member when they are selected. They will be able to register and make payment via the Web site, mail or personally in the home office.

Once registered, the member will have a log-in and password which will allow them access to a restricted ‘members only’ page on the Web site where they will have access to a monthly newsletter and information in regards to the amount of funds available for the upcoming random selection. The page will also include information in regards to who received the prior month debt payment(s). This page will only be available to active members.

Once an individual is selected, the individual will be notified by the organization and given instruction on what actions to take to have his or her debt paid. Members will remain eligible as long as their dues are paid regardless if they have been previously selected.

The debt payment process will involve the member collecting his or her debt information to include account and phone numbers. Via a three-way conversation between the member, the creditor and the organization, the organization will arrange for electronic funds transfer (EFT) or mail payment of the members' debt processed directly to the creditor. If a member is selected in one month and has his or her total debts paid, that member can be randomly selected again the following month. However, the likelihood of this individual having additional personal debt is minimal. No member is removed from the active membership as long as their dues are paid. Dues are nonrefundable.

The payment of an individual debt can be accomplished through a gift from the organization thus eliminating a tax burden to the member. The member receives the benefit of the funds without actually personally receiving the funds. The current U.S. tax code allows a specific amount to be given as a personal gift per year per individual. Members will acknowledge through registration in the organization their individual consent in allowing a specified amount of their periodic (preferably monthly or annual but can be weekly or bi-weekly as well) dues to be given as a gift to another randomly selected member.

Each employee of the organization will be required to register as a member of the organization and pay their yearly dues. Employees of the organization are not eligible to receive benefits of their membership. This practice will serve as an indication of the strict requirements of trust, ethics and integrity expected from the organization. How is it possible to believe in the success of a program if you are not an active participant? In fact, employees are knowingly contributing to the payment of debt of other members without the opportunity to personally benefit. That's commitment.

There are and will be opportunities to expand on this practice and principles in the future. Several ideas are in the works, however initial success of this process is paramount. One idea is to institute revenue sharing. Any member personal information that is shared with an outside agency will result in revenue sharing with members. For instance, if company A wants information on active members for a specific amount, the organization will share at least a portion of that amount with members by adding that amount to the funds available to pay members' debt.

The payoff of personal debt has no odds because the amount available varies as well as the number of individuals eligible. This can not be compared to a lottery system because in a lottery system the odds are based on number combinations and has nothing to do with the number of individuals participating, except to the extent that the number participating may limit the lottery winnings. With this system as long as there are active members and the amount available exceeds the amount of debt of the individuals selected, there will be someone getting their debt paid. With this system there can be no rollover of the monthly sum. All available funds will be distributed paying members debt, month after month.

The initial (first) random selection process will not take place until there is in excess of a pre-set amount, such as $10,000.00, available for payment to the selected member. Due to this policy, it is anticipated that a pre-set amount of $10,000 will most likely not pay the entire debt of an individual. The first selection should be made as soon as possible to maintain the integrity of the process and organization and not have the members wait for an extended period of time before the initial payment is made. One can not predict how long it will take before the organization will be able to generate enough members to have a significant amount available to pay a selected individual's entire debt. A positive reputation is paramount and paying a member as soon as possible is one way of establishing that reputation.

### EXAMPLE

These examples are given without regard to monetary deductions of processing and administrative fees. The random process mention involves initiating the selection process on the next day following consecutive 30 days or the next business day if the next day is a weekend or holiday.

Assume the organization is active on the first of the month and active members (those who registered and paid dues) generate approximately $10,000.00 (preferably the minimum). That means $10,000.00 will be available to pay personal debts. The random process is initiated. It is acknowledges that $10,000.00 may not pay the entire debt of the selected individual. It is the intention of the organization to make a payment as soon as possible to demonstrate the integrity and professionalism of the organization. Members should not have to wait for an extended period of time before someone benefits. Of course, there is no way of calculating how long it will take to establish active membership capable of generating the funds needed to pay the entire debt of a selected individual. This procedure will be instituted until such time as the organization or its membership can completely pay a member's debt before selecting another member for that month.

Assuming there are active members in the organization and approximately $100,000.00 generated as available funds to pay a selected member's debt. The random process is initiated. If a specific member is selected and his or her debt exceeds the amount available, no other selection is made. That member is not eligible to receive funds from the following month to pay off their debt since there are not enough funds consistently generated to pay debts.

Assuming there are active members in the organization and approximately $250,000.00 is generated as available funds to pay a selected member's debt. The random process is initiated. If the selected member has a total debt of $200,000.00, that debt is paid and there is a remaining sum $50,000.00. Another random selection is made and that member has $50,000.00 paid toward his or her debt. If the $50,000.00 completely pays that member's debt, no other selection is made until the next month. If the $50,000.00 will only pay a portion of that member's debt, the remainder will be paid from the following months sum before another random selection is made. This is the procedure since enough funds are consistently generated to pay the debts.

Assuming there are active members in the organization and approximately $500,000.00 is generated as available funds to pay a selected member's debt. The random process is initiated. If the selected member has in excess of the maximum amount payable in debt, the entire amount goes to that member and no other selection is made for that month. The member will inform the organization as to how to distribute the sum toward their debt.

Assuming there are active members in the organization and approximately $1,000,000.00 is generated as available funds to pay a selected member's debt. The random process is initiated. Assume the first member selected has $250,000.00 in total debt, the second member selected has $250,000.00 in total debt, the third member selected has $250,000.00 in total debt, the fourth member selected has $100,000.00 in total debt, the fifth member selected has $150,000.00 in total debt. Five active members have their debt paid for that month. No other selection is made for that month the funds have been completely exhausted.

Assuming there are active members in the organization and approximately $2,000,000 is generated as available funds to pay a selected member's debt. The random process is initiated. Assume first member selected has $180,000.00 in total debt, the second member selected has $220,000.00 in total debt, the third member selected has $500,000 in total debt, the fourth member selected has $350,000.00 in total debt, the fifth member selected has $110,000.00 in total debt and the sixth member selected has $250,000.00 in total debt, and the seventh member selected has $280,000.00 in total debt with $110,000.00 remaining. The eighth member selected has $480,000.00 in total debt therefore $110,000.00 goes toward that members debt this month and the remaining $370,000.00 is paid from the following month's available funds before the random selections for the following month are made. Eight members had their debts paid based on the amount available.

The organization may also find it desirable to set a limit toward any individual payout. For example, the organization may set a limit on a total debt to be paid as $500,000.00. In this case, had the third member's debt total $600,000.00, only a maximum of $500,000.00 would have been paid.

Assume an active member is randomly selected and that member has $350,000.00 in personal debt. In addition, assume his or her spouse has $12,000.00 in credit card debt in his or her name. The organization will only pay the debt in the name of the active member if that member is the principal (primary) debt holder. For example, the credit cards are in the active member's name with the spouse as an additional cardholder, the organization will pay that debt. If the spouse is the principal (primary) debtor on the credit card or any other debt (auto), the organization will not pay that debt unless they are an active member and their name is randomly selected. This policy does not affect home loans. It is the decision of spouses as to whether or not both or only one of them registers as an active member of the organization.

In still another example of how this system or method of debt elimination works for its members, assume there was a single person who won a Mega Lottery in the amount (before taxes) of $290 million. If that amount was available to this organization to pay member debts and the average debt is $250,000.00, approximately 1,160 members would have their debts paid for that month. Keeping in mind, the inventors herein believe there are no tax liabilities based on the current tax code.

An objection or concern might be: Why isn't the entire amount paid by members available to the members to pay debts? There are inherent costs associated with operating a business or organization. Processing payments online in addition to administrative costs associated with paying for a Web site, employees, benefits, equipment, software, office space, legal fees, insurance, etc. However, in the scheme of things the amount designated, as administrative fees is insignificant compared to what members are paying in interest to creditors as well as the amount traditional corporations or organizations impose as mark up.

Another objection or concern might be: Why doesn't the first person selected when there is a minimum of $10,000.00 have their total debt paid? This process is driven solely by active membership. Only the funds available and generated by membership can and will be used to pay off debts. It will benefit members to help advertise and increase the amount available to pay off debt. It is preferably desirable that the initial amount will significantly exceed $10,000.00, but it is felt that a pre-set amount like $10,000.00 would be a good starting point to pay out the initial payment. Unfortunately, the first person selected can't have their debts paid if the active membership does not support it. This process is self-reliant. The organization can not generate funds where they do not exist and it can not calculate how long it will take to accumulate an amount significant enough to pay off all the member's debt initially.

Another issue or concern may be the fact that once a person pays off their mortgage they will have a significant tax burden. It is true that many individuals use the interest paid on their mortgage to offset the amount they pay in federal income tax. Individuals must consider their future tax liabilities prior to joining the organization. In addition, there are numerous financial/tax advisors who can give advice to individuals as to alternate tax shelters available. It is anticipated that members will be made aware of this fact via a monthly newsletter. In this newsletter, financial advice will not be given but it will be recommend that individuals seek the advice of a reputable tax/financial advisor and not simply succumb to the fact that they need to remain in debt to benefit from tax breaks.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A debt elimination method wherein:
providing an organization, the organization being an individual membership only organization;
each individual joins the organization to become a member by registering and paying a registration fee and a membership dues, wherein each registered individual further consents that his or her payments of the dues in combination with dues paid by other members are combined and given as gifts for the purpose of personal debt elimination;
each individual member further pays said monthly dues to be an active member and maintain his or her active membership status;
funds available for personal debt elimination are calculated from the dues paid by the active members on a monthly basis; and
an active member is randomly selected monthly and the available funds are paid directly to that randomly selected member's creditors wherein said selected member's personal debts are eliminated.

2. The method according to claim 1, wherein at least a portion of the dues is included in the available funds.

3. The method according to claim 1, wherein when the organization is first started, a pre-set limit of funds will be made available on a monthly basis until the organization is able register new members so as to generate sufficient funds to pay a selected member's entire debt in subsequent months.

4. The method according to claim 1, wherein the registration for membership is completed through an online organization Web site.

5. The method according to claim 1, wherein the registration for membership is completed at an office of the organization or by mail.

6. The method according to claim 1, wherein the registration fee is a one time, life-time registration fee.

7. The method according to claim 1, wherein the individual member optionally joins the organization for a desired period.

8. The method according to claim 7, wherein the desired period is a number of months, years or fractions of said years.

9. The method according to claim 1, wherein each active member is provided with log-in means and selects a personal password to allow said active member a restricted members only access to a Web site for the organization.

10. The method according to claim 9, wherein each active member is allowed access to a monthly newsletter and organizational information, said information to include the amount of funds available for an upcoming random selection of an active member for whom, personal debts will be paid, and information in regard as to which active member(s) were randomly selected for personal debt elimination in a prior month.

11. The method according to claim 1, wherein the randomly selected active member for a specific month is eligible for being randomly selected again in a future month as long his or her membership remains active by the continuous payment of said monthly dues.

12. The method according to claim 1, wherein the randomly selected member's personal debts are paid by the membership organization through an electronic funds transfer system or by mail.

13. The method according to claim 1, wherein
there is no rollover of said available funds should the personal debts of the randomly selected member not exceed the available funds,
additional random selections are made until all the available funds are distributed, and
any personal debt shortfall for the last randomly selected member will be taken from a following month's available funds.

14. The method according to claim 12, wherein the amounts due creditors of the randomly selected member are verified using a three-way telephone call between the randomly selected member, an official of the organization and each creditor.

15. The method according to claim 1, wherein employees and officials of the organization are ineligible to participate in the debt elimination method.

16. The method according to claim 1, wherein the organization generates revenues and allocates a percentage share of said revenues to be shared by the active members, and said allocated shares of revenues are further added to the available funds for payment of the personal debts of the randomly selected members.

17. The method according to claim 13, wherein the organization determines a maximum amount of personal debt that is payable to any of the randomly selected members.

18. A method for eliminating personal debts, wherein individuals register and pay a registration fee as members of an organization for the purpose of being randomly selected for having their personal debts paid as well as for the purpose of contributing to the payment of debts of other active members, wherein the members consent that the fees paid to the organization and made available for personal debt elimination be given as gifts for the purpose of said personal debt elimination.

19. The method according to claiml8, wherein
available funds are used to pay said personal debts of the randomly selected member,
there is no rollover of said available funds should the personal debts of the randomly selected member not exceed the available funds,
additional random selections are made until all the available funds are distributed, and
any personal debt shortfall for the last randomly selected member will be taken from a following month's available funds.

20. The method according to claim 19, wherein the organization determines a maximum amount of personal debt that is payable to any of the randomly selected members.

21. A method for eliminating personal debts, wherein individual dues received from a member of an organization in combination with that of other members of said organization are combined and given as gifts for the purpose of personal debt elimination.

22. A method for eliminating personal debts, wherein combined dues, incentives and revenue from individuals and corporations are used by a membership organization to pay an active member's debt through an electronic funds transfer system or by mail, wherein all payments for debts are considered gifts from the members of the organization.

23. A method for eliminating personal debts, wherein members' dues are used in accordance with federal tax codes such the amount used to pay a randomly selected member's personal debts is considered a gift from other members of a membership organization.

24. A method for eliminating personal debts, wherein electronically or by mail, members join a membership organization and receive monthly financial updates to inform and educate said members on financial matters, members review funds available on a periodic basis for debt payment and review the name(s) of those who have had their debts paid in previous months, wherein all payments for debts are considered gifts from the members of the organization.

25. The method according to claim 24, wherein
the available funds are used to pay said personal debts of the randomly selected member,
there is no rollover of said available funds should the personal debts of the randomly selected member not exceed the available funds,
additional random selections are made until all the available funds are distributed, and
any personal debt shortfall for the last randomly selected member will be taken from a following month's available funds.

26. The method according to claim 25, wherein the organization determines a maximum amount of personal debt that is payable to any of the randomly selected members.
